(19) United States
(12) Patent Application Publication
(10) Pub. No.: US 2025/0362161 A1
(43) Pub. Date: Nov. 27, 2025

(54) MEASURING SYSTEM

(71) Applicant: Endress+Hauser SE+Co. KG, Maulburg (DE)

(72) Inventors: Sergey Lopatin, Lörrach (DE); Anh Tuan Tham, Berlin (DE); Peter Klöfer, Steinen (DE); Volker Frey, Schopfheim (DE); Benjamin Scherer, Oberried (DE)

(21) Appl. No.: 18/872,365

(22) PCT Filed: Jun. 1, 2023
(86) PCT No.: PCT/EP2023/064690

§ 371 Date: Dec. 6, 2024

(30) Foreign Application Priority Data
Jun. 13, 2022 (DE) 10 2022 114 875.0

(51) Int. Cl. G01F 1/32; G01L 1/12

(52) U.S. Cl. CPC G01F 1/3209; G01F 1/3227; G01L 1/125

(57) ABSTRACT

A measuring system for measuring a flow parameter of a fluid flowing in a pipeline includes: a pipe; a bluff body arranged in the pipe and designed to generate vortices in the fluid flowing past the bluff body; a vortex sensor arranged downstream of the bluff body, the vortex sensor designed to produce mechanical vibrations upon being excited by the flowing fluid and to provide a vortex sensor signal and having a magnetostrictive material; a magnetic field detection unit designed to measure a change in a magnetic field resulting from mechanical forces acting on the magnetostrictive material and designed to provide a magnetic field detection signal; and transmitter electronics for analyzing the vortex sensor signal and for analyzing a functionality and/or a plausibility statement regarding the vortex sensor signal provided by the vortex sensor based on the magnetic field detection signal.

The invention relates to a measuring system for measuring at least one flow parameter, in particular a time-variable flow parameter, in particular a flow velocity and/or a volume flow rate and/or a mass flow rate, of a fluid measurement substance flowing in a pipeline, in particular a gas, a liquid or a dispersion, in particular a vortex flow meter.

In process measurement and automation technology, measuring systems designed as vortex flow meters are often used for the measurement of flow velocities of fluids flowing in pipes, especially fast flowing and/or hot gases and/or fluid flows of high Reynolds number (Re), or of volume flow rates or mass flow rates corresponding to a respective flow velocity (u). Examples of such measuring systems are known, inter alia, from US 2006/0230841, US 2008/0072686, US 2011/0154913, US 2011/0247430,US 2016/0123783, US 2017/0284841, US 2019/0094054, U.S. Pat. Nos. 6,003,384, 6,101,885, 6,352,000, 6,910,387, or 6,938,496 and are also offered, inter alia, by the applicant, for example, under the trade names “PROWIRL D 200,” “PROWIRL F 200,” “PROWIRL O 200,” “PROWIRL R 200” (http://www.de.endress.com/#products/prowirl).

Each of the measuring systems shown has a resistance element, which protrudes into the lumen of the respective pipeline, namely, for example, designed as a system component of a heat supply network or of a turbine circuit or into a lumen of a measurement tube used in the course of said pipeline, against which resistance element fluid flows to generate vortices which are lined up to form a so-called Kármán vortex street within the partial volume of the fluid flow flowing directly downstream of the resistance element. As is known, the vortices are generated at the resistance element at a shedding rate (1/f_{Vtx}) which is dependent on the flow velocity. Furthermore, the measuring systems have a sensor which is integrated in the resistance element or connected therewith or downstream thereof, namely in the region of the Kármán vortex street into the flow, thus into the lumen of the projecting sensor, which sensor is used to detect pressure fluctuations in the Kármán vortex street formed in the flowing fluid and to convert them into a sensor signal representing the pressure fluctuations, namely to supply a signal—here, for example, an electrical or optical signal—that corresponds to a pressure prevailing within the fluid, which, due to opposing vortices, is subjected to periodic fluctuations downstream of the resistance element, or has a signal frequency (˜f_{Vtx}) corresponding to the shedding rate of the vortices.

For this purpose, the sensor has a deformation element and a—usually rod-shaped, planar, or wedge-shaped—sensor lug extending from a substantially planar surface of the deformation element, and is designed to detect pressure fluctuations in the Kármán vortex street, namely to convert them into movements of the deformation element corresponding to the pressure fluctuations. The deformation element has an outer edge segment—usually circular-ring-shaped—which is configured to be hermetically sealed, e.g., integrally bonded, to a socket which is used to hold the deformation element on a wall of a pipe such that the deformation element covers and hermetically seals an opening provided in the wall of the pipe and that the surface of the deformation element supporting the sensor lug faces the fluid-carrying lumen of the measurement tube or of the pipeline, and therefore the sensor lug projects into said lumen. The deformation element is typically designed as a thin membrane and is shaped such that at least one membrane thickness, measured as a minimum thickness of an inner membrane segment bounded by the above-mentioned outer edge segment, is much less than a membrane diameter, measured as a largest diameter of a surface bounded by the outer edge segment. In order to achieve with the sensor lug the highest possible measurement sensitivity, namely a highest possible sensitivity of the sensor to the pressure fluctuations to be detected and, at the same time, an as high as possible mechanical natural frequency, which is above the highest shedding rate to be measured, for the flexural vibration mode of the deformation element, which is forced by the pressure fluctuations, such deformation elements of established measuring systems typically have a diameter-to-thickness ratio, which is approximately of the order of 20:1. As shown, inter alia, in the above-mentioned US-A 2016/0123783, US-A 2017/0284841, US-A 2019/0094054, or US-B 63 52 000, sensors of the type in question can occasionally also have a usually rod-shaped, planar, or sleeve-shaped compensating element that extends from a surface, facing away from the surface supporting the sensor lug, of the deformation element and is used especially to compensate for forces or moments resulting from movements of the sensor assembly, e.g., as a result of vibrations of the pipe, or to avoid undesired movements of the sensor lug resulting therefrom.

For the purpose of generating the sensor signal, each of the sensors further comprises a (mechanical-to-electrical) transducer element, which is typically configured to detect movements of the deformation element and convert them into an electrical sensor signal. In the sensors known from US-A 2017/0284841, US-A 2019/0094054, or U.S. Pat. No. B 63 52 000, said transducer element is formed by means of a piezo ceramic, for example, in the form of a piezo disk.

On a side facing away from the fluid-carrying lumen, the sensor is furthermore connected to a transducer electronics system, which is typically encapsulated in a pressure-tight and impact-proof manner and optionally also hermetically sealed towards the outside. The transducer electronics of measuring systems which are suitable for industrial applications usually have a corresponding digital measurement circuit, which is electrically connected to the transducer element via connection lines, optionally with the interposition of electrical barriers and/or galvanic isolation points, for processing the at least one sensor signal generated by the transducer element and for generating digital measurement values for the measured variable to be detected in each case, namely the flow velocity, the volume flow rate, and/or the mass flow rate. The transducer electronics system, usually accommodated in a protective housing made of metal and/or impact-resistant plastic, of measuring systems suitable for industry or established in industrial measurement technology also usually provide external interfaces conforming to an industry standard, e.g., DIN IEC 60381-1, for communication with higher-level measurement and/or regulator systems, for example, formed by means of programmable logic controllers (PLC). Such an external interface can be designed, for example, as a two-wire connection which can be incorporated into a current loop and/or be compatible with established industrial field buses.

Not least due to the relatively high diameter-to-thickness ratios of the deformation element, which are due to the measurement principle, conventional sensors of the type in question—even when a high-strength nickel-based alloy is used, such as, for example, Inconel 718 (Special Metals Corp.), as material—usually have a compressive strength, that is to say a maximum permissible operating pressure, above which a non-reversible plastic deformation of the sensor or even a bursting of the deformation element is to be provided, which may be too low for the extremely high pressures or pressure shocks which occasionally actually occur in certain applications, or such sensors show a dependence of said compressive strength upon the operating temperature (pressure-temperature curve), which dependence is too disadvantageous for such applications, such that, for example, for operating pressures above 100 bar, which occasionally occur in actually predestined hot steam applications with steam temperatures of above 200° C.—for example, as a result of condensation-induced water hammers (CIWH)—nondestructive resistance can no longer be guaranteed.

A newer development in the field of sensor technology is represented by so-called quantum sensors, in which a wide variety of quantum effects are utilized for determining various physical and/or chemical measured variables. In the field of industrial process automation, such approaches are of interest in particular with regard to increasing efforts towards miniaturization, while at the same time increasing the performance of the respective sensors.

Quantum sensors are based upon the fact that certain quantum states of individual atoms can be controlled and read very precisely. In this way, for example, precise and low-interference measurements of electrical and/or magnetic fields as well as gravitational fields with spatial resolutions in the nanometer range are possible. In this context, various spin-based sensor assemblies have become known, for which atomic transitions in crystal bodies are used for detecting changes of movements, electrical and/or magnetic fields or also gravitational fields. Furthermore, different systems based on quantum-optic effects have also become known, such as quantum-gravimeters, NMR gyroscopes or optically pumped magnetometers, wherein in particular the latter are based, inter alia, on gas cells.

For example, in the field of spin-based quantum sensors, various devices have become known that utilize atomic transitions, for example in various crystal bodies, in order to detect even small changes in movements, electric and/or magnetic fields or even gravitational fields. Typically, diamond having at least one nitrogen vacancy center, silicon carbide having at least one silicon vacancy, or hexagonal boron nitride having at least one vacancy color center is used as crystal body. The crystal bodies can in principle have one or more vacancies.

DE 10 2017 205 099 A1 discloses a sensor device having a crystal body with at least one vacancy, a light source, a high-frequency device for applying a high-frequency signal to the crystal body, and a detection apparatus for detecting a magnetic-field-dependent fluorescence signal. The light source is arranged on a first substrate, and the detection device is arranged on a second substrate, while the high-frequency device and the crystal body can be arranged on the two interconnected substrates. External magnetic fields, electrical currents, temperature, mechanical stress or pressure can be used as measured variables. A similar device has become known from DE 10 2017 205 265 A1.

DE 10 2014 219 550 A1 describes a combination sensor for detecting pressure, temperature and/or magnetic fields, wherein the sensor element has a diamond structure with at least one nitrogen vacancy center.

DE 10 2018 214 617 A1 discloses a sensor device which also has a crystal body with a number of color centers, in which device various optical filter elements are used to increase effectiveness and for miniaturization.

From the heretofore unpublished German patent application with the file number 10 2020 123 993.9, a sensor device has become known which uses a fluorescence signal of a crystal body with at least one vacancy in order to evaluate a process variable of a measurement substance. In addition, a state monitoring of the respective process is carried out on the basis of a variable related to the magnetic field, such as the magnetic permeability or magnetic susceptibility. From the German patent application with the file number 10 2021 100 223.0, which also has not yet been published, a point level sensor has also become known in which a statement about a point level is determined on the basis of the fluorescence.

Many applications in process measurement and automation require very reliable measuring systems which ensure that the specified measurement accuracy is maintained.

The invention is based on the object of proposing a measuring system for measuring at least one flow parameter, which system reliably provides measured values with a predetermined measurement accuracy.

The object is achieved by the measuring system according to claim 1.

The measuring system according to the invention for measuring at least one flow parameter, in particular a time-variable flow parameter, in particular a flow speed and/or a volume flow rate and/or a mass flow rate, of a fluid measurement substance flowing in a pipeline, in particular a gas, a liquid or a dispersion, comprises:
a pipe insertable into the course of said pipeline and having a lumen, which is configured to guide the measurement substance flowing in the pipeline or to allow said measurement substance to flow through it;
a bluff body, in particular a prismatic or cylindrical bluff body, which is arranged in the lumen of the pipe and is configured to generate vortices in the measurement substance flowing past at a shedding frequency fᵥ, dependent on a current flow speed, u, of said measurement substance, such that a Kármán vortex street is formed in the fluid flowing downstream of the bluff body;
a vortex sensor, arranged downstream of the bluff body,
   having at least one mechanical resonant frequency, f_{R}, which is, in particular, lowest and/or always above the shedding frequency f_{V}, and
   being configured, when excited by the flowing measurement substance, to effect mechanical oscillations around a static rest position and to provide at least one, in particular electrical or optical, vortex sensor signal which represents said oscillations, and
   having a magnetostrictive material;
a magnetic field detection unit which is designed to measure a change in a magnetic field as a result of the effect of mechanical forces acting on the magnetostrictive material and which is designed to provide a magnetic field detection signal representing the same effect, in particular an electrical or optical magnetic field detection signal;
and transmitter electronics, in particular formed by means of at least one microprocessor, for analyzing the at least one vortex sensor signal, for ascertaining measured values, in particular digital measured values, for the at least one flow parameter and for analyzing a functionality and/or a plausibility statement regarding the vortex sensor signal supplied by the vortex sensor on the basis of the magnetic field detection signal.

By monitoring the functionality of the measuring system, it is ensured that the vortex sensor reliably provides measured values within the guaranteed measurement accuracy throughout its service life. If the deviation of the measured values exceeds a prespecified limit, this is an indication that the measuring system needs to be serviced or replaced. This monitoring can be carried out continuously or during scheduled maintenance intervals. In addition, it is alternatively or additionally provided that the measuring system supplies redundant measured values continuously or at predetermined time intervals, which at least allow a plausibility statement regarding the supplied measured values. This makes it possible to use the measuring system according to the invention in safety-critical applications as well.

Magnetostriction is the change in the geometric dimensions of a ferromagnetic body under the influence of a magnetic field. This effect is measurable in all ferromagnetic materials. In connection with the invention, the opposite effect, the so-called Villari effect, comes into play, i.e., the change in the magnetic field or in the magnetic properties of the magnetostrictive material under the influence of mechanical forces acting on the material is considered. Among the elements or metals in their pure form, iron, nickel and cobalt exhibit ferromagnetic properties at room temperature. The fourth element with ferromagnetic properties at room temperature has been identified as ruthenium in the metastable body-centered tetragonal phase. Ferromagnetic alloys such as AlNiCo, SmCo, Nd2Fe14B, Ni80Fe20 (“Permalloy”), or NiFeCo alloys (“Mumetal”) are suitable for practical applications. Which ferromagnetic material is used in connection with the invention depends on whether the ferromagnetic material comes into contact with the measurement substance or whether it is arranged in isolation from the measurement substance.

The magnetostrictive material itself does not generate its own magnetic field, but changes its permeability under the influence of an acting force μ. To measure changes in the magnetic field, it is therefore necessary to generate an offset magnetic field, e.g., by using a permanent magnet or a coil. Changes in the magnetic field resulting from a force acting on the magnetostrictive material can be measured using the magnetic field detection unit.

Advantageous embodiments of the invention are the subject matter of the dependent claims.

One embodiment provides that the vortex sensor has a deformation element, in particular a membrane-like and/or disk-shaped deformation element, with a first surface facing the lumen and an opposite second surface in particular at least partially parallel to the first surface, and
wherein the vortex sensor has at least one transducer element arranged above and/or on the second surface of the deformation element, in particular attached namely to the deformation element and/or positioned in the vicinity thereof, which is configured to detect movements of the deformation element, in particular of the second surface thereof, and convert them into the vortex sensor signal.

One embodiment provides that the vortex sensor has a sensor lug, in particular a planar or wedge-shaped sensor lug, extending from the first surface of the deformation element to a distal end.

One embodiment provides that the deformation element is made of the magnetostrictive material, is coated with the magnetostrictive material or is at least partially covered by a body comprising the magnetostrictive material.

One embodiment provides that the sensor lug is made of the magnetostrictive material, coated with the magnetostrictive material or at least partially covered by a body comprising the magnetostrictive material.

One embodiment provides that the deformation element or the sensor lug is provided with the coating made of the magnetostrictive material, is made of the magnetostrictive material or is covered by the body comprising the magnetostrictive material, at least in a partial region in which a maximum mechanical stress or a maximum deflection occurs during the oscillation about the static rest position.

In principle, known magnetic field detection units can be used in connection with the invention. Preferably, however, the magnetic field detection unit is a quantum sensor. Quantum sensors have become known in a wide variety of designs. They use different quantum effects to determine various physical and/or chemical process variables. In the field of industrial process automation, the use of quantum sensors is interesting in two respects: Quantum sensors make it possible to miniaturize the sensors used, while at the same time increasing their performance.

One embodiment provides that the magnetic field detection unit is a quantum sensor.

One embodiment provides that the quantum sensor has at least one crystal body having at least one magnetic-field-sensitive vacancy.

Preferably, two types of quantum sensor are used in conjunction with the measuring system. The magnetic field detection unit can be a quantum sensor which has at least one crystal body having at least one magnetic field-sensitive vacancy. The crystal body can be, for example, a diamond having at least one nitrogen vacancy, silicon carbide having at least one silicon vacancy, or hexagonal boron nitride having at least one vacancy color center. Of course, there can also be a plurality of vacancies in the crystal body. These are preferably arranged linearly. An increase in the number of vacancies leads to an increased intensity, so that measurement resolution is improved and intensity changes can be detected even in the case of comparatively weak magnetic fields.

A large number of quantum sensors which can be used in process automation have already become known from the patent literature. For example, DE3742878A1 describes an optical magnetic sensor in which a crystal is used as a magnet-sensitive optical component.

DE 102017205099 A1 discloses a sensor device having a crystal body having at least one vacancy, a light source, a high-frequency device for applying a high-frequency signal to the crystal body, and a detection unit for detecting a magnetic-field-dependent fluorescence signal. The light source is arranged on a first substrate, and the detection device is arranged on a second substrate, while the high-frequency device and the crystal body can be arranged on the two interconnected substrates. External magnetic fields, electrical currents, temperature, mechanical stress or pressure can be used as measured variables. A similar apparatus has become known from DE102017205265A1.

DE 102014219550 A1 describes a combination sensor for detecting pressure, temperature and/or magnetic fields, wherein the sensor element has a diamond structure with at least one nitrogen vacancy center.

DE 102018214617 A1 discloses a sensor device which also has a crystal body with a number of color centers, in which device various optical filter elements are used to increase effectiveness and for miniaturization.

DE 102016210259 A1 proposes a further embodiment of a sensor apparatus as well as a calibration and evaluation method based on vacancies in a crystal. The sensor apparatus comprises a crystal body having at least one vacancy, a light source, a microwave antenna for applying microwaves to the crystal body, a detection device for detecting fluorescence from the crystal body, and an application device by means of which an induction current can be applied to the microwave antenna. The microwave antenna serves both to generate microwaves and to generate an internal magnetic field. The internal magnetic field makes calibration possible during continuous operation.

One embodiment provides that the magnetic field detection unit has an excitation apparatus, in particular an optical excitation apparatus, for exciting the vacancy or for exciting the gas cell, and a detection apparatus, in particular an optical detection apparatus, for detecting a magnetic-field-dependent signal of the crystal body or of the gas cell.

The invention is explained in greater detail with reference to the following figures.

In the drawings:

FIG. 1: is a perspective view of a measuring system, in particular a vortex flow meter;

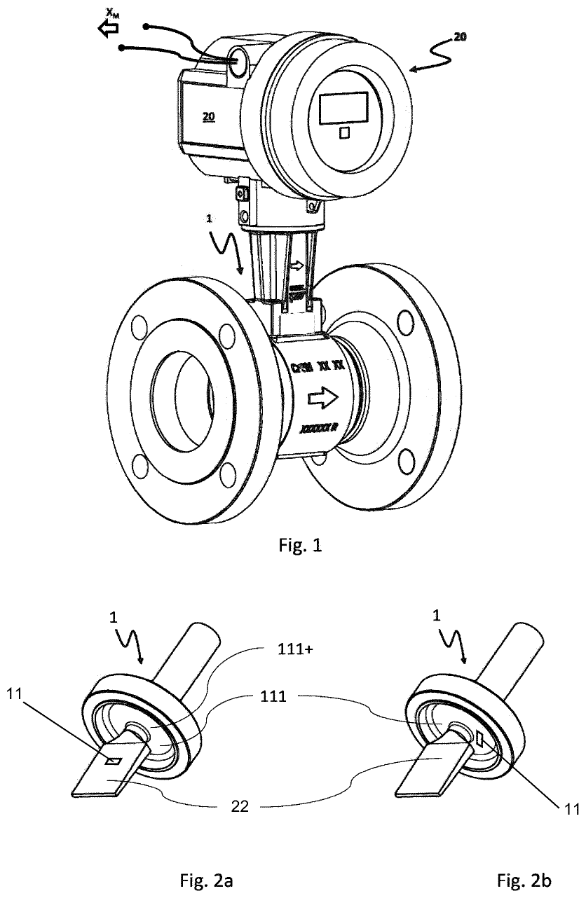

FIG. 2a: is a perspective view of a first embodiment of the vortex sensor;

FIG. 2b: is a perspective view of a second embodiment of the vortex sensor;

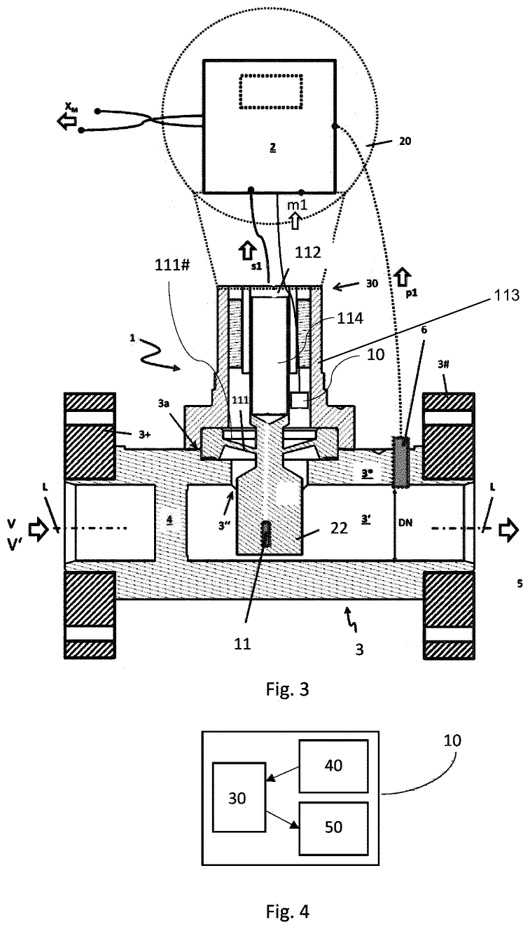

FIG. 3: is a longitudinal section through an embodiment of the measuring system; and

FIG. 4: is a schematic representation of an embodiment of the magnetic field detection unit.

FIG. 1 is a perspective view of a measuring system for measuring at least one flow parameter, optionally also variable over time, such as a flow velocity v and/or a volume flow rate V′, a fluid flowing in a pipeline, for example a hot gas having, in particular, at least temporarily a temperature of more than 200° C., and/or being at least temporarily under a high pressure, in particular, of more than 100 bar, in particular a vortex flow meter. The pipe can be designed, for example, as a plant component of a heat supply network or of a turbine circuit, and therefore the fluid can be, for example, steam, especially saturated steam or superheated steam, or else, for example, a condensate discharged from a steam line. However, fluid can also, for example, be (compressed) natural gas or a biogas, so that the pipe can also be a component of a natural gas or biogas plant or of a gas supply network, for example.

The measuring system has a vortex sensor 1, shown again enlarged in FIG. 3, which is provided or configured to detect pressure fluctuations in the fluid flowing past the sensor in a (main) flow direction and to convert it into a sensor signal s1 corresponding to said pressure fluctuations-for example, an electrical or optical sensor signal s1. As is apparent from FIGS. 1 and 3 when viewed together, the measuring system furthermore comprises transmitter electronics 2—for example, accommodated in a pressure-resistant and/or impact-resistant protective housing 20—electrically connected to the vortex sensor 1 or which communicate with the vortex sensor 1 during operation of the measuring system. The transmitter electronics 2 are, in particular, configured to receive and process the sensor signal s1, namely, for example, to generate measurement values XM representing the at least one flow parameter, i.e., for example, the flow velocity v or the volume flow rate V′. The measurement values XM can, for example, be visualized on the spot and/or—in a wired manner via a connected field bus and/or in a wireless manner via radio—be transmitted to an electronic data processing system, for example a programmable logic controller (PLC), and/or to a process control station.

The protective housing 20 for the transmitter electronics 2 can, for example, be produced from a metal, such as a stainless steel or aluminum, and/or by means of a casting method, such as an investment casting or die casting method (HPDC); it can however, for example, also be formed by means of a plastic molded part produced in an injection molding method.

As shown in FIG. 3 or as readily apparent from FIG. 2a/b and 3 when viewed together, the vortex sensor 1 comprises a deformation element 111, in particular, a membrane-like or disk-shaped deformation element, as well as a sensor lug 22 having a left-side first side face and a right-side second side face, which, starting from a first surface 111+ of the deformation element 111, extends up to a distal (free) end that is namely remote from the deformation element 111 or its surface 111+. The deformation element 111 further has a second surface 111 #, which is opposite the first surface 111+—for example, at least partially parallel to the first surface 111+. The deformation element 111 and the sensor lug 22 can, for example, be components of one and the same monolithic molded part that is cast or produced by an additive manufacturing process such as 3D laser melting, for example; however, the deformation element and the sensor lug can also be designed as individual parts that are initially separate from one another and are only subsequently integrally bonded to one another, e.g., welded or soldered to one another, and therefore produced from materials that can correspondingly be integrally bonded to one another. The deformation element 111 can consist at least partially, namely, for example, predominantly or completely, of a metal such as stainless steel or a nickel-based alloy. The sensor lug can likewise consist at least partially of a metal, namely, for example, stainless steel or a nickel-based alloy; the deformation element 111 and the sensor lug 22 can in particular also be produced from the same material. The deformation element 111 and the sensor lug 22 are moreover, in particular, configured to be excited to—typically forced—oscillations about a common static rest position in such a way that the sensor lug 22 executes pendular movements which elastically deform the deformation element 111 in a detection =direction running substantially transversely to the aforementioned flow direction. The sensor lug 22 accordingly has a width, measured as a maximum extent in the direction of the flow direction, which is substantially greater than a thickness of the sensor lug 22, measured as a maximum lateral extent in the direction of the detection direction. Moreover, the sensor lug 22 can be designed, for example, as a wedge-shaped or also as a relatively thin planar plate, as is quite common with such sensors.

Apart from the sensor lug 22 and the deformation element 111, the vortex sensor 1 furthermore has a connection sleeve 113 extending from a circular circumferential edge segment of the second surface 111 #of the deformation element, which edge segment extends, for example, in circular form. In order to detect oscillations of the deformation element 111 and the sensor lug, the vortex sensor 1 furthermore has at least one transducer element 112, in particular a disk-shaped and/or piezoceramic transducer element, which is arranged within the connection sleeve 113 and contacts the surface 111+ of the deformation element with a first contact surface, for generating an electrical sensor signal representing temporally changing, in particular at least temporarily periodic, movements of the sensor lug and/or likewise temporally changing, in particular at least temporarily periodic, deformations of the deformation element 111, for example with a (alternating) voltage corresponding to the aforementioned movements.

According to a further embodiment of the invention, the measuring system further comprises a pipe 3 which can be inserted into the course of the aforementioned pipeline and has a lumen 3′ which is surrounded by a wall 3*, e.g., a metallic wall, of the pipe and extends from an inlet end 3+ to an outlet end 3 #and is configured to guide the fluid flowing in the pipeline. The vortex sensor 1 is moreover inserted into said pipe in such a way that the first surface of the deformation element 111 faces the lumen 3′ of the pipe, so that the sensor lug projects into said lumen. In the exemplary embodiment shown here, there is at both the inlet end 3+ and the outlet end 3 #a flange, which is used in each case to create a leak-free flange connection to a corresponding flange on an inlet-side or outlet-side line segment of the pipeline. Furthermore, as shown in FIG. 1 or 3, the pipe 3 can be substantially straight, for example, in the form of a hollow cylinder with a circular cross-section in such a way that the tube 3 has an imaginary straight longitudinal axis L connecting the inlet end 3+ and the outlet end 3 #. In the exemplary embodiment shown in FIG. 1 or 3, the vortex sensor 1 is inserted into the lumen of the pipe from the outside through an opening 3″ formed in the wall and is fastened, e.g., also releasably, from the outside to the wall 3* in the region of said opening in such a way that the surface 111+ of the deformation element 111 faces the lumen 3′ of the pipe 3, and therefore the sensor lug 22 projects into said lumen. In particular, the vortex sensor 1 is inserted into the opening 3″ in such a way that the deformation element 111 covers or hermetically seals the opening 3″. Said opening can be designed, for example, in such a way that it has, as is quite usual in measuring systems of the type in question, an (inner) diameter in a range between 10 mm and approximately 50 mm. According to a further embodiment of the invention, a socket 3a used to hold the deformation element 111 or the sensor 1 formed therewith on the wall 3* is formed in the opening 3″. In this case, the vortex sensor 1 can, for example, be fastened to the tube 3 by integral bonding, especially by welding or soldering, of the deformation element 111 and wall 3*; however, it can for example also be detachably connected to the tube 3, for example, screwed thereto or screwed thereon. Furthermore, at least one sealing face, e.g., also a circumferential or circular-ring-shaped sealing face, can be formed in the socket 3a and is configured to seal the opening 3″ correspondingly in cooperation with the deformation element 111 and an optionally provided, e.g., annular or annular disk-shaped, sealing element.

In the exemplary embodiment shown in FIG. 1 or 3, the measuring system is specifically designed as a vortex flow meter with a resistance element 4 arranged in the lumen of the pipe 3—here, namely upstream of sensor 1, namely in the (main) direction of flow upstream of the sensor—and serving to create a Kármán vortex street in the flowing fluid. Here, the sensor and the resistance element are, in particular, dimensioned and arranged such that the sensor lug 22 projects into the lumen 3* of the pipe, or into the fluid conducted therein, in such a region which during operation of the measuring system is regularly taken up by a (stationarily formed) Kármán vortex street, so that the pressure fluctuations detected by means of the sensor 1 are periodic pressure fluctuations caused by vortices shed at the resistance element 4 at a shedding rate (˜1/f_{Vtx}), and the sensor signal s1 has a signal frequency (˜f_{Vtx}) corresponding to the shedding rate of said vortices. In the exemplary embodiment shown here, the vortex flow meter is moreover designed as a compact-type measuring system in which the measurement electronics 2 are accommodated in a protective housing 20 held on the pipe—for example, by means of a neck-like connection piece 30.

According to a further embodiment of the invention, in order to compensate for forces and/or moments resulting from random movements of the sensor—e.g., as a result of vibration of the aforementioned pipeline connected to the pipe—or to prevent undesired movements of the sensor lug or of the deformation element 111 resulting therefrom, namely which distort the sensor signal s1, the vortex sensor 1 further has a compensating element 114, e.g., a rod-shaped, planar, or sleeve-shaped compensating element, extending from the second surface 111 #of the deformation element 111. The compensating element 114 can, for example, consist of the same material as the deformation element and/or the sensor lug, for example a metal. For example, the compensating element 114 can be produced from stainless steel or a nickel-based alloy. According to a further embodiment of the invention, the deformation element 111 and the compensating element 114 are integrally bonded to one another, for example welded or soldered to one another, and therefore the compensating element 114 and the deformation element 111 are produced from materials that can be integrally bonded to one another accordingly. Alternatively, however, the deformation element 111 and the compensating element 114 can also be components of one and the same monolithic molded part, for example also in such a way that the sensor lug 111, the deformation element 112 and the compensating element 114 are components of said molded part. The sensor lug 22 and the compensating element 114 can also be arranged in alignment with one another in such a way that a main axis of inertia of the sensor lug 22 coincides in extension with a main axis of inertia of the compensating element 114. Alternatively or in addition, the compensating element 114 and the deformation element 111 can also be positioned and aligned with one another such that a main axis of inertia of the deformation element 111 coincides in extension with a main axis of inertia of the compensating element 114.

FIG. 1 in conjunction with 3 shows that the vortex sensor 1 comprises a magnetostrictive material 11 and a magnetic field detection unit 10 which is designed to measure a change in a magnetic field as a result of mechanical forces acting on the magnetostrictive material 11 and which is designed to provide a magnetic field detection signal m1 representing the same action, in particular an electrical or optical magnetic field detection signal. The transmitter electronics 2 are suitable and configured to use the at least one vortex sensor signal to determine measured values, in particular digital, measured values X_{M}, for the at least one flow parameter and to analyze a functionality and/or a plausibility statement regarding the vortex sensor signal s1 supplied by the vortex sensor 1 on the basis of the magnetic field detection signal m1.

According to the invention, a suitable magnetic field detection unit 10 is provided which measures the magnetic field which occurs in the magnetostrictive material as a result of the mechanical forces acting on the vibratable unit 4 (Villari effect). A control/evaluation unit, which is part of the transmitter electronics 2 of the measuring system, generates a statement about the functionality of the vortex sensor 1 on the basis of the measured magnetic field and/or makes a plausibility statement regarding the vortex sensor signal s1 supplied by the vortex sensor.

Preferably, the magnetic field detection unit 10 is a quantum sensor. Different embodiments of quantum sensors have already been described in detail above, so there is no need to repeat them here. Compared to conventional magnetic field detection sensors, such as Hall sensors, quantum sensors have the advantage that they are small in size—i.e., they can also preferably be integrated into the vibronic sensor 1—and measure with extreme sensitivity. Of course, it is also possible to design the magnetic field detection unit 10 as a separate component and to place it outside the vortex sensor 1 in such a way that the magnetic field is measured. The magnetostrictive material 11 generates a magnetic field with the aid of a magnet, e.g., a permanent magnet which generates an offset magnetic field, a magnetic field which can be measured by the magnetic field detection unit 10 with the required accuracy. The magnetostrictive material 11 itself does not generate its own magnetic field, but changes its permeability under the influence of a force μ acting on it. For this reason, it is necessary to generate an offset magnetic field, e.g., by means of a permanent magnet or a coil, in order to measure the change in the magnetic field due to a force acting on the magnetostrictive material 11. Although the use of a quantum sensor for analyzing the magnetic field is preferred in connection with the present invention, it goes without saying that depending on the embodiment and arrangement of the magnetostrictive material 11 and of the permanent magnet on the vortex sensor 1, a conventional magnetic field sensor can also be used.

FIG. 2a is a perspective view of a first embodiment of the vortex sensor 1. The sensor lug 22 is at least partially coated with the magnetostrictive material 11 or at least partially covered by a body comprising the magnetostrictive material 11.

FIG. 2b is a perspective view of a second embodiment of the vortex sensor 1. The deformation element 111 is coated with the magnetostrictive material 11 at least in portions. The deformation element 111 or the sensor lug 22 comprise the magnetostrictive material 11 at least in a partial region in which a maximum mechanical stress or a maximum deflection occurs during the oscillation about the static rest position.

Alternatively, the sensor lug 22 and/or the deformation element 111 can be made of the magnetostrictive material 11.

The quantum sensor shown schematically in FIG. 4 comprises at least one magnetic-field-sensitive nitrogen vacancy center (NV center) in a diamond. The following considerations can be transferred to other crystal bodies 30 having corresponding vacancies.

In the diamond, each carbon atom is typically covalently bonded to four further carbon atoms. A nitrogen vacancy center (NV center) consists of a vacancy in the diamond lattice, i.e., an unoccupied lattice site, and a nitrogen atom as one of the four neighboring atoms. In particular, the negatively charged NV⁻ centers are important for the excitation and evaluation of fluorescence signals. In the energy diagram of a negatively charged NV center, there is a triplet ground state ³A and an excited triplet state ³E, each of which has three magnetic substates mₛ=0, ±1. Furthermore, there are two metastable singlet states ¹A and ¹E between the ground state ³A and the excited state ³E. In the absence of an external magnetic field, a splitting of the two states mₛ=+/−1 from the ground state mₛ=0 occurs, which is referred to as zero field splitting Δ and which is dependent upon the temperature T.

Excitation light from the green range of the visible spectrum, e.g., an excitation light with a wavelength of 532 nm, excites an electron from the ground state 3A into a vibrational state of the excited state 3E, which returns to the ground state 3A by emitting a fluorescence photon with a wavelength of 630 nm. This fluorescence signal is a measure of the zero field splitting Δ and can be used to determine and/or monitor the temperature T.

An applied magnetic field with a magnetic flux density leads to a splitting (Zeeman splitting) of the magnetic substates, so that the ground state consists of three energetically separated substates, each of which can be excited. However, the intensity of the fluorescence signal is dependent on the respective magnetic substate from which it was excited, so that the magnetic flux density B, for example, can be calculated using the Zeeman formula on the basis of the distance between the fluorescence minima. This principle is used in magnetic field detection units with a microwave-generating apparatus. In this case, the magnetic flux density or the smallest changes in the magnetic flux density can be determined. However, quantum sensors are also known which make use of the properties of ground-state level anti-crossing (GSLAC) and can therefore be operated without microwaves. For further details, reference is made to the publications “Microwave-free magnetometry with nitrogen-vacancy centers in diamond” by Wickenbrock et al. and “NV-NV electron-electron spin and NV-NS electron—electron and electron-nuclear spin interaction in diamond” by Armstrong et al.

In the context of the present invention, further possibilities for evaluating the fluorescence signal are provided, such as the evaluation of the intensity of the fluorescent light, which is likewise proportional to the applied magnetic field. An electrical evaluation can in turn be done, for example, via a Photocurrent Detection of Magnetic Resonance (PDMR). Alternatively, as already described, various excitation-query sequences can be used for targeted control and manipulation of the nuclear spins. In addition to these examples for evaluating the fluorescence signal, there are other possibilities which also fall within the scope of the present invention.

FIG. 4 shows a schematic longitudinal section through an embodiment of the magnetic field detection unit 10, in particular of the quantum sensor, wherein the magnetic field detection unit 10 has an excitation apparatus 40, in particular an optical excitation apparatus, for exciting the vacancy or for exciting the gas cell, and a detection apparatus 50, in particular an optical detection apparatus, for detecting a magnetic-field-dependent signal of the crystal body 30 or of the gas cell. The optical excitation apparatus 40 is designed to excite the crystal body by generating an optical excitation signal, in particular light with a fixed frequency, in order to polarize the vacancy center in the crystal body. The excitation apparatus 40 can be, for example, a light source, in particular a laser. Alternatively, there can also be a large number of vacancy centers in the crystal body. The optical detection device 50 is designed to detect the fluorescence signal emitted by the crystal body and to provide a measurement signal comprising the intensity of the fluorescence signal. For example, a photodiode in combination with a lock-in amplifier is suitable as an optical detection apparatus. Optionally, filters and mirrors as well as further optical elements can be used to direct an excitation light to the crystal body and/or the fluorescence signal towards the detection apparatus. Instead of one crystal body, a plurality of crystal bodies can also be provided in the form of a crystal-body coating.

1-10. (canceled)

11. A measuring system for measuring at least one time-variable flow parameter of a fluid flowing in a pipeline, the measuring system comprising:
a measuring tube adapted to be insertable into a course of the pipeline, the measuring tube defining a lumen, configured to guide the fluid flowing in the pipeline or to enable the fluid to flow therethrough;
a bluff body disposed in the lumen of the measuring tube and configured to generate vortices in the fluid flowing passed the bluff body at a shedding frequency such that a Kármán vortex street is formed in the fluid flowing downstream of the bluff body, wherein the shedding frequency is dependent on a current flow velocity of the fluid;
a vortex sensor arranged downstream of the bluff body, the vortex sensor:
adapted so as to have at least one mechanical resonant frequency equal to a lowest and/or always above the shedding frequency;
configured to effect, in a manner excited by the flowing fluid, mechanical oscillations around a static rest position and to provide at least one electrical or optical vortex sensor signal, which represents the oscillations; and
including a magnetostrictive material;
a magnetic field detection unit configured to measure a change in a magnetic field resulting from mechanical forces acting on the magnetostrictive material and to generate and provide an electrical or optical magnetic field detection signal representing the mechanical forces acting on the magnetostrictive material; and
transmitter electronics, including at least one microprocessor, configured to evaluate the at least one vortex sensor signal, to determine measured values of the at least one flow parameter, and to determine a functionality and/or a plausibility statement regarding the at least one vortex sensor signal provided by the vortex sensor based on the magnetic field detection signal.

12. The measuring system according to claim 1, wherein the vortex sensor includes:
a deformation element, which is membrane-like and/or disk-shaped, including a first surface facing the lumen and an opposite second surface, which is at least partially parallel to the first surface; and
at least one transducer element arranged above and/or on the second surface of the deformation element, the at least one transducer element configured to detect movements of the deformation element and to convert the movements into the vortex sensor signal, wherein the at least one transducer element is attached to the deformation element and/or positioned in a vicinity thereof.

13. The measuring system according to claim 12, wherein the vortex sensor includes a sensor lug, which is planar or wedge-shaped, extending from the first surface of the deformation element to a distal end.

14. The measuring system according to claim 12, wherein the deformation element is made of the magnetostrictive material, coated with the magnetostrictive material, or at least partially covered by a body comprising the magnetostrictive material.

15. The measuring system according to claim 13, wherein the sensor lug is made of the magnetostrictive material, coated with the magnetostrictive material, or at least partially covered by a body comprising the magnetostrictive material.

16. The measuring system according to claim 13, wherein the deformation element or the sensor lug is provided with the coating made of the magnetostrictive material, is made of the magnetostrictive material, or is covered by the body comprising the magnetostrictive material, at least in a partial region in which a maximum mechanical stress or a maximum deflection occurs during the oscillations about the static rest position.

17. The measuring system according to claim 11, wherein the magnetic field detection unit is a quantum sensor.

18. The measuring system according to claim 17, wherein the quantum sensor includes at least one crystal body having at least one magnetic field-sensitive vacancy.

19. The measuring system according to claim 18, wherein the magnetic field detection unit includes an optical excitation apparatus configured to excite the at least one magnetic field-sensitive vacancy and includes an optical detection apparatus configured to detect a magnetic field-dependent signal of the at least one crystal body.

20. The measuring system according to claim 17, wherein the quantum sensor comprises at least one gas cell.

21. The measuring system according to claim 18, wherein the magnetic field detection unit includes an optical excitation apparatus configured to excite the at least one the gas cell and includes an optical detection apparatus configured to detect a magnetic field-dependent signal of the at least one the gas cell.

22. The measuring system according to claim 11, wherein the at least one time-variable flow parameter is at least one of a flow velocity, a volume flow rate, and a mass flow rate.

23. The measuring system according to claim 11, wherein the fluid is a gas, a liquid, or a dispersion.

24. The measuring system according to claim 11, wherein the bluff body is a prismatic or cylindrical bluff body
